(19) United States
(12) Patent Application Publication
(10) Pub. No.: US 2008/0120143 A1
(43) Pub. Date: May 22, 2008

(54) Method for Providing Discounted Insurance

(75) Inventors: Thomas Raymond Beauregard, Ridgefield, CT (US); Theodore Alan Prospect, Wilton, CT (US); Jeffrey Wayne Kagan, Farmingville, NY (US); James Richard Braue, Glastonbury, CT (US); Stephen Richard Bosworth, Wilbraham, MA (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Uniprise, Inc.

(21) Appl. No.: 11/561,282

(22) Filed: Nov. 17, 2006

(51) Int. Cl. G06Q 40/00

(52) U.S. Cl. 705/4

(57) ABSTRACT

A discount provision under an insurance policy allows an entity to pay a required premium to provide future access and a discount for future insurance coverage under the insurance policy, the future insurance coverage available upon a predetermined event. A method for providing an insurance policy having a discount provision includes creating a discount provision under an insurance policy, under which an entity pays a required premium, to provide future access and a discount for future insurance coverage under the insurance policy, said future insurance coverage available upon a predetermined event, collecting the required premium amount from the entity for a first period of time; and upon cessation of payment of the required premium by the entity, providing insurance coverage to the entity and discounting the insurance premiums for a second period of time.

### FIELD OF THE INVENTION

The present invention relates to providing health and other types of insurance to individuals who are no longer covered under an insurance policy. More specifically, the present invention provides a method for providing an individual with an insurance policy having discounted premiums.

### BACKGROUND OF THE INVENTION

In order to defray the costs of health care, individuals, families, and other entities such as employers routinely purchase health insurance policies. Generally, health insurance policies provide that, in exchange for the policyholder's payment of a premium, the health insurance company will cover some or all of the health care costs incurred by the individuals covered under the policy.

Employer-provided health insurance policies provide coverage for employees while employed. Medicare or other federally funded health insurance coverage only covers individuals who have reached the age of eligibility, e.g., 65 years, or who have qualified for other reasons. However, when an individual ceases to be employed before becoming eligible for federally funded health insurance, individual medical insurance coverage may be difficult to find due to poor health or other circumstances that cause the individual to be uninsurable. Furthermore, even if the individual has health insurance coverage available to them, the premium payments may be too costly to afford.

Furthermore, an individual receiving employer-sponsored health insurance benefits may sever their relationship with their health insurance company when changing employers or when retiring early. As a result, the health insurance company may be unable to retain their consumer relationship, monitor the consumer's health status, or provide services to the consumer to address their changing needs.

### BRIEF SUMMARY OF THE INVENTION

In view of the drawbacks described above, the present invention provides a method for providing discounted health and other types of insurance. Health insurance, may include medical insurance, dental insurance, pharmaceutical insurance, and/or insurance for other health-related products and services. One such method provides affordable post-employment health insurance coverage for individuals who have not yet qualified for federal medical insurance coverage, e.g., Medicare, by paying pre-discount premiums for at least a predetermined period of time that provides an entity with a right of access to discounted future insurance. In a further implementation, pre-discount premiums are used to pre-fund future premiums for a health insurance policy over a period of time. This enables funds to accumulate so that upon retirement, the funds may be used to pay all or a portion of a policyholder's health insurance premiums, and as a result, the policyholder does not carry the full financial burden of paying insurance premiums once they are no longer employed. According to some implementations, after payment of the requisite pre-discount premiums, an early retiree may receive insurance coverage under, for example, a guaranteed issue health insurance policy, thereby enabling the retiree to forego underwriting before qualifying for insurance coverage. This may provide advantages for those who have developed medical conditions after enrolling in an insurance policy having a discount provision.

In one embodiment, a method for providing an insurance policy having a discount provision includes creating an insurance policy having a discount provision under which an entity pays a required premium to provide future access and a discounted price for future insurance coverage, the future insurance coverage available upon one or more predetermined events, collecting the required premium amount from the entity for a first period of time, and upon cessation of payment of the required premium by the entity, providing insurance coverage to the entity and discounting the insurance premiums for a second period of time.

Another method according to the present invention provides for funding of future medical benefits by enabling an insured policyholder to elect to receive, for example, reduced benefits in the present time, and to contribute the savings resulting from this election to a fund that will allow future access to medical coverage to be available at a discount. For example, the policyholder may be guaranteed health insurance through their early retirement years, e.g., ages 55-65, or may have an option to receive future health insurance even if they become unemployed, or if COBRA insurance is not available.

The methods of providing an insurance policy having a discount provision may be directed towards a group model that ties money from a payment vehicle to post-employment insurance, or towards individual models. For example, under a group model, the insurance policy having a discount provision may provide individual employees the option of taking a reduced contribution or subsidy from an employer in order to purchase a portable insurance product that the employee can keep even if employment ceases. Alternatively, the methods may provide a portable insurance product that allows an individual to take employer contributions, e.g., pre-tax contributions, and purchase safety net insurance coverage before becoming eligible to receive federally funded health insurance. Moreover, the insurance policy having a discount provision may be associated with an active medical benefits plan such as an employer-sponsored or group medical insurance plan. The insurance policy having a discount provision also may be associated with an active medical benefits plan providing benefits to employees under an administrative services only (ASO) plan or “self-funded” plan. In this case, the insurance company provides administrative services only for the active benefits plan, and the employer or other sponsor of the plan is responsible for funding the benefits under the ASO arrangement or self-funded plan.

The methods for providing an insurance policy having a discount provision may also apply to other types of insurance, such as life, disability, liability, or property insurance to enable entities to avoid gaps in insurance coverage as their circumstances change.

These and other features and advantages of the present invention will become apparent to those skilled in the art from the following detailed description, wherein it is shown and described illustrative embodiments of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 depicts a method for providing an insurance policy having a discount provision.

FIG. 1A depicts a method for providing another insurance policy having a discount provision.

FIG. 2 depicts a method for providing a portable insurance policy having a discount provision.

FIG. 3 depicts various methods for providing an insurance policy having a discount provision.

### DETAILED DESCRIPTION OF THE INVENTION

A health insurance policy having a discounting aspect and a method for providing a health insurance policy having a discounting aspect for discounting future insurance, e.g., future, post-employment health insurance, are provided. The method includes receiving pre-discount premium payments for an insurance policy having a discount provision up to a predetermined event, which allows an entity to cease paying pre-discount premiums (e.g., in the case of retirement or loss of employment) after the predetermined event occurs, and to begin paying discounted premiums in exchange for receipt of insurance coverage. Thus, the initial premiums paid prior to the occurrence of a predetermined event maintains an individual's option to receive access to future insurance, e.g., the individual policyholder is able to activate future insurance coverage, and provides a discount for the future insurance coverage. The insurance benefits and premium discount may be guaranteed so that if an individual develops a medical condition after enrolling in the insurance policy, the type and price of coverage are not affected.

Premiums that are initially paid under the health insurance policy having the discount provision may be considered pre-discount premiums and may be used to discount future insurance coverage. Premiums paid after the pre-discount period ends may be considered discount premiums and may be discounted by the pre-discount aspect of the insurance policy. Therefore, pre-discount premiums may be paid during a pre-discount period, and discount premiums may be paid during a discount period. According to certain configurations, the pre-discount period may begin upon enrollment in the insurance policy having the discount provision, and may end at the earliest of the enrollee opting out of the pre-discount provision, the enrollee reaching an appropriate retirement age, or the enrollee becoming eligible for Medicare. In alternative configurations, a deferral period may fall between a pre-discount period and a discount period, where an entity ceases to pay pre-discount premiums and does not elect to receive coverage in which a portion of the premiums are discounted.

For purposes of certain implementations of the invention, an insurance provision may be composed of features, terms and conditions of a typical insurance policy, an insurance policy provision, an insurance rider, or a right except where the policies would be affected by an insurance policy having a discount provision, e.g., a funding provision that allows future insurance to be discounted, such as insurance for post-employment or early retirement.

An entity may be a person, a family unit, a corporation, an association, a union, a trust, a Taft-Hartley trust, a group of unions or employers or associations, or another qualified group where members are eligible to receive insurance benefits.

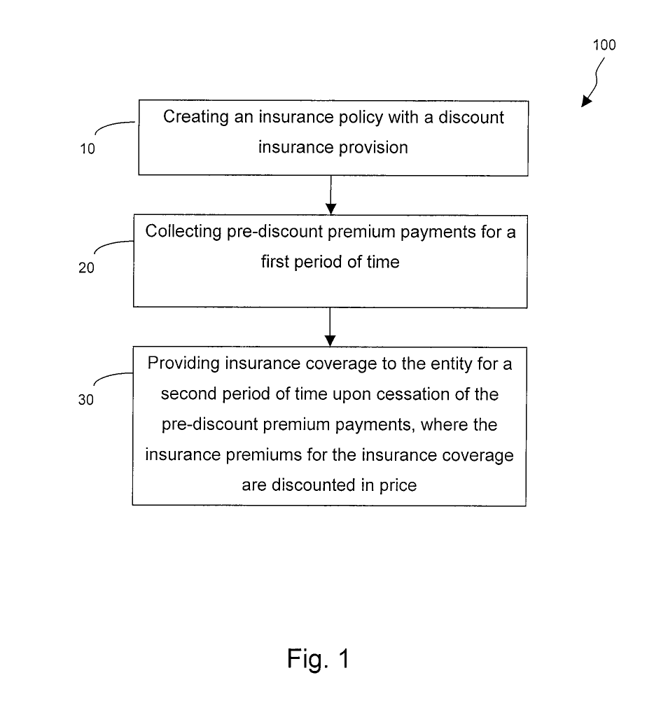

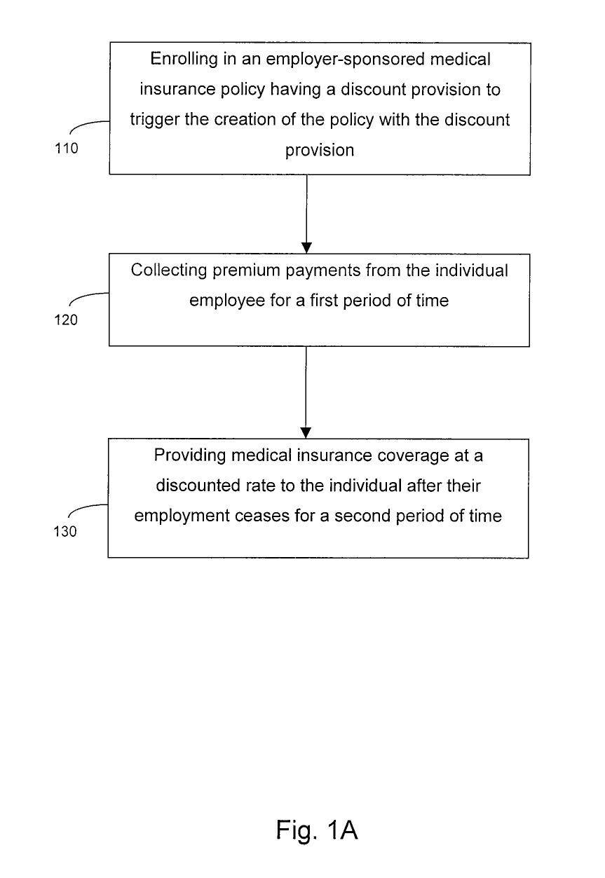

FIG. 1 provides an exemplary embodiment of a method 100 for providing a discount provision under an insurance policy. Method 100 involves creating 10 an insurance policy with a discount insurance provision, collecting 20 pre-discount premium payments for a first period of time, and upon cessation of paying pre-discount premiums, providing 30 insurance coverage to the entity for a second period of time where the insurance premiums for the insurance coverage are discounted. Providing 30 insurance coverage may be under the same insurance policy having the discount provision, or may be effected through another insurance policy. Maintaining the insurance policy with the discount provision by paying pre-discount premiums is what allows an entity to elect receive the future insurance coverage for the second period of time at a discounted rate. The first period of time may end and the second period of time may begin, for example, upon a predetermined event set forth in the insurance policy.

In one exemplary embodiment, the method of FIG. 1 is depicted in FIG. 1A. In this method, an individual employee enrolling 110 in an employer-sponsored medical insurance policy having a discount provision as part of an enrolling group triggers creation of the policy. Collection 120 of premium payments from the individual employee for a first period of time enables the insurer to provide 130 medical insurance coverage at a discounted rate to the individual after their employment ceases for a second period of time.

In another alternative, a group enrolling in a group insurance policy having a discount provision triggers creation of the insurance policy, and insurance provided after the pre-discount period ceases may be provided with a discounted group rate or price. In a further alternative, an individual enrolls in an individual insurance policy having a discount provision, and insurance provided after the pre-discount period ceases may be provided with a discounted individual rate or price.

The amount paid for the insurance policy having a discount provision over time, according to some configurations, may be set to meet a target accumulation, such as a percentage of the projected cost of premiums for a predetermined period of time after cessation of employment, e.g., projected cost of retiree premiums from the date of retirement to the date of the end of the discount period, and may be set as 10, 20, 30, 40, or 50 percent of the projected cost of premiums, for example. According to additional configurations, the premium amount under discount provision may be adjusted based on forecasted increases in medical costs or to reflect changes in the target accumulation. Adjustments in the amount of funds contributed may be absorbed by the individual's employer, or may be partly or wholly the responsibility of the individual employee. In addition, the amount of funds required for providing access to the discount provision may be adjusted to cover costs related to the discount provision and/or the insurance policy itself such as administrative costs, risks, mortality, age of retirement, profit margins, and adverse selection.

In order to maintain a right of access to future discounted insurance, pre-discount premium payments may be required to be made up to one or more predetermined events. Predetermined events may include: election to receive insurance coverage having discounted premiums, payment of pre-discount premiums for a predetermined period of time such as 6 months, 1 year, 3 years, 5 years, or for a predetermined time according to employer guidelines or the insurance policy itself; and/or payment of pre-discount premiums up to an age such as a retirement age of 50-64, or up to an age set according to employer guidelines or the insurance policy itself. Alternatively, a predetermined event may be that an individual policyholder attains an age, e.g. 50-64, retires, becomes incapacitated, or becomes Medicare eligible due to age or disability.

In some implementations, where a predetermined event is not an election, an individual may be required to elect to receive insurance coverage after the occurrence of one or more predetermined events. Alternatively, activation of insurance policy having the discount provision may occur automatically once an entity experiences a predetermined event, e.g., reaching a predetermined age or status. In another alternative, when an individual ceases paying pre-discount premiums and experiences a predetermined event, an election requirement may be waived and coverage with discounted premiums may be automatically provided. Discounted insurance may be provided for a discount period that may be a predefined period of time or to a predetermined age for an individual policyholder, for example.

The amount of the premium discount may be a portion of the funds accumulated during the pre-discount period. In some implementations, the amount of the premium discount may be a fixed dollar amount, for example, and may be adjusted annually based on the entity's past contributions, future inflation, or projected future medical inflation. In another implementation, the amount of the premium discount may be a fixed percentage of the premium, or may be a variable percentage of the premium that may fall within a percentage range. In another implementation, the amount of the premium discount may be a pre-paid amount. In yet another implementation, the amount of the premium discount may be determined upon initiation of the discount period. This may be beneficial for individuals that pay pre-discount premiums past a retirement age, e.g., past age 60, and elect to receive benefits at a discounted price before reaching an age of 65. In further alternatives, the percentage may be a percentage of a group rate at retirement.

In some implementations, terms of the insurance policy having the discount provision may include, for example, that an entity be required to have active insurance coverage during the pre-discount period or that the insurance policy having the discount provision be tied to an active employer-sponsored insurance plan. When an entity has an insurance policy having a discount provision and an employer-sponsored insurance plan, the two may originate from the same insurer or different insurers. In these implementations, the insurance coverage received during the pre-discount period may be the same as the coverage provided once the discount period begins. In other embodiments, the coverage provided upon the initiation of the discount period may be tailored to the entity's circumstances. In addition, an entity's active insurance coverage received during the pre-discount period may be required to meet certain minimum benefit requirements. For example, a minimum benefit requirement may be that the active insurance plan have at least an equal amount of benefits compared to the insurance policy having the discount provision. In addition, the insurance policy having the discount provision may be associated with an ASO arrangement or other self-funded plan in which an entity, such as an employer, is responsible for funding benefits for active employees, and the insurer is responsible for providing administrative services with respect to the benefits for active employees.

In some implementations, a funding vehicle may be created in which funds may accumulate and may be used for future premium payments, e.g., after the occurrence of a predetermined event. According to some aspects, a portion of the premiums paid by the individual during the pre-discount period are deposited into a funding vehicle such as an annuity or a tax-favored account (TFA) such as an health savings account or a healthcare reimbursement arrangement. A directed annuity may be useful for an individual employee or a self-employed individual because funds may be built up individually. Furthermore, a directed annuity may be assigned to an insurance company, thereby allowing payment from the annuity to directly fund an individual's future insurance products and premiums.

In addition, as an alternative to, or in addition to funding an annuity, payment vehicles such as TFAs may be used to as a payment vehicle. For example, a healthcare reimbursement arrangement may be a restricted use TFA used solely for funding future health insurance during the pre-discount period. In other alternatives, a TFA may have other uses, such as for holding funds usable for payment of qualified medical expenses under the individual's active insurance policy. However, at least a portion of the funds in the TFA is preferably held for the limited use of funding future insurance coverage. In one example the individual's TFA vests over a predetermined period, e.g., 6 months, 1 year, or 5 years, and the individual becomes eligible to receive discounted benefit options after that time.

In addition, by contributing to the directed annuity or TFA an individual may fully fund future health insurance products so that rather than offsetting payments for future insurance premiums, all of the individual's premiums are covered by the funds in the directed annuity and/or TFA.

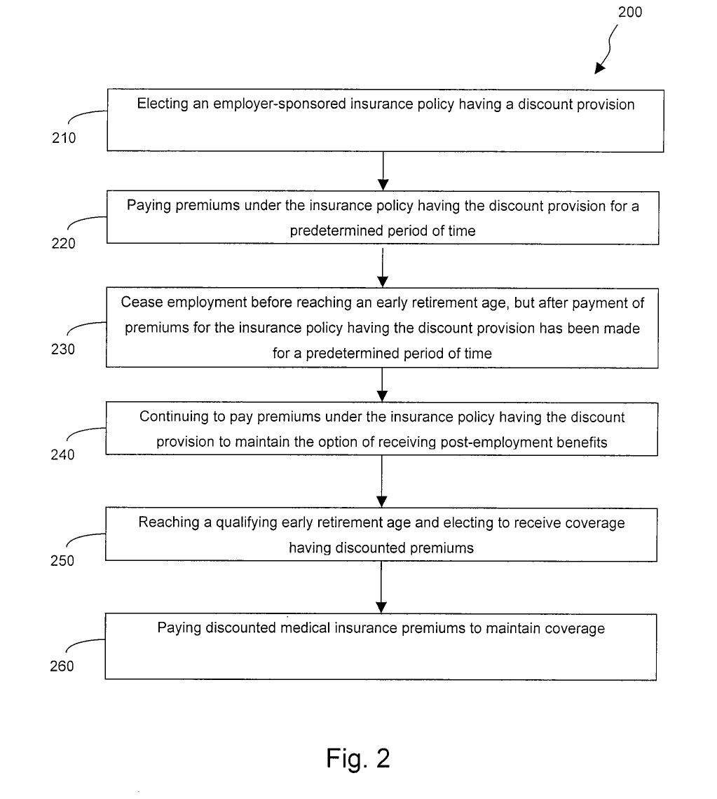

FIG. 2 depicts an exemplary embodiment of a method 200 for providing a portable discounted post-employment medical insurance plan. According to FIG. 2, the method includes electing 210 an employer-sponsored insurance policy having a discount provision. In some instances, in order for an entity to elect the policy having a discount provision, it may be required to meet certain eligibility requirements specified by the provision and/or the employer. For example, an entity may be required to show proof of active insurance coverage.

After the election 210 of the insurance policy having a discount provision, the method includes paying 220 premiums for the discount provision for a predetermined period of time, e.g., a pre-discount period. Premium payments may originate from an individual's pre-tax salary, taxable dollars, from employer contributions, or combinations thereof.

According to method 200, when employment ceases 230 before an individual reaches an early retirement age, but payment of premiums during the pre-discount period have been made for a predetermined period of time, e.g., a period of 6 months, 1 year, or 5 years, continued payment of premiums 240 under the discount provision maintains the option of receiving post-employment benefits. In some instances, the employer-sponsored insurance policy converts to an individual insurance policy that is portable. Conversion to a portable policy may be contingent on providing proof of alternate health insurance during the period before reaching the qualifying age. In further embodiments, an individual may be required to undergo underwriting in order to convert to a portable policy.

Upon reaching 250 a qualifying early retirement age and electing to receive coverage having a discounted price, benefits may be maintained by paying 260 discounted medical insurance premiums, where the cost of the premiums are discounted due to payments made during the previous pre-discount period. Benefits may be provided to the policyholder until they qualify to receive federally funded medical coverage.

Method 200 is an illustration of providing a portable insurance policy having a discount provision. Portable early retirement policies may allow an individual to change employment where limited or no employer-sponsored post-employment insurance is offered without the risk of losing post-employment benefits. Under certain circumstances, however, the employee may cease employment before paying premiums for the predetermined period of time, e.g., a pre-discount period of 6 months, 1 year, or 5 years, and the post-employment policy does not qualify as being portable. In these instances, the individual or the individual's beneficiaries may be refunded all or a portion of the contributed funds, or the funds may be used to pay for other medical insurance premiums, e.g., COBRA. Alternatively, once elected, the post-employment benefits may be fully portable and independent of the employment relationship.

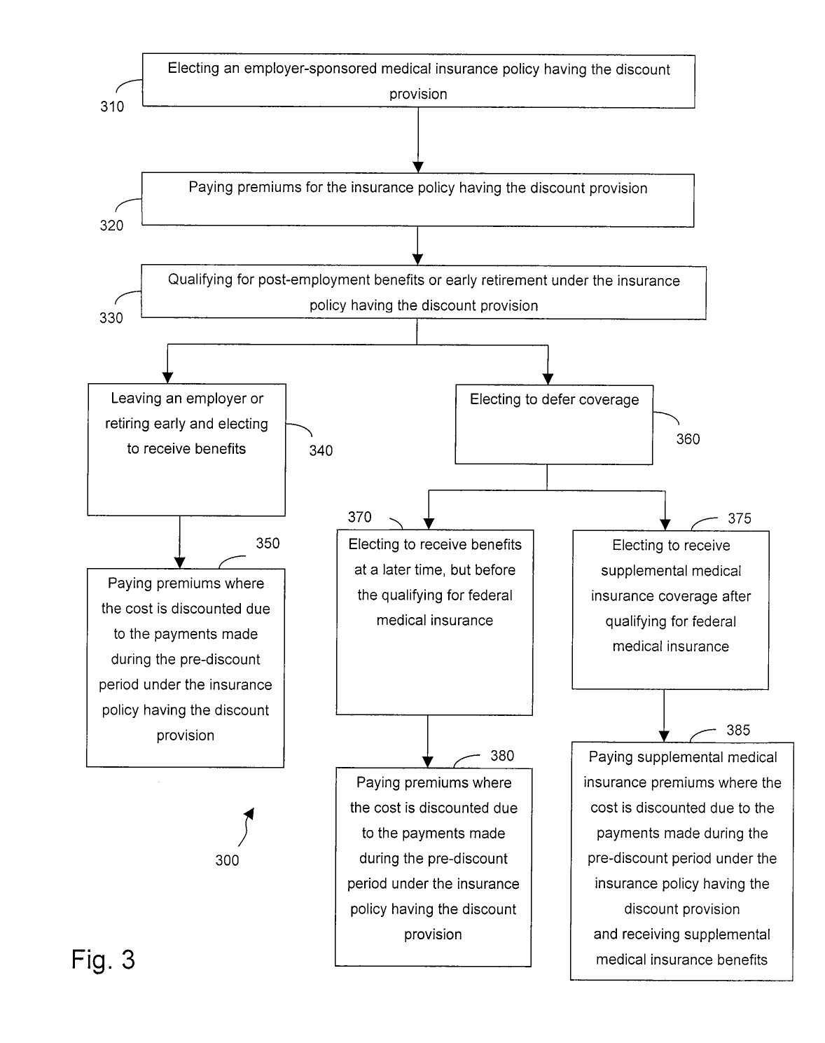

FIG. 3 depicts a method 300 for providing an insurance policy with a discount provision having a variety of implementations. According to FIG. 3, the method 300 includes electing 310 an employer-sponsored medical insurance policy having a discount provision; paying 320 premiums for the insurance policy having the discount provision; and qualifying 330 for post-employment benefits or early retirement under the insurance policy having the discount provision.

In some implementations, the individual may be required to contribute funds for a predetermined period of time before qualifying 330 for post-employment benefits or early retirement, i.e., for a predefined pre-discount period. For example, a time period between 1 and 5 years may be required before an individual is eligible to receive access to the funds associated with the insurance policy having the discount provision.

According to certain configurations, the individual may qualify 330 to receive discounted insurance benefits based on the occurrence of pre-determined events set forth in the terms of the insurance policy having the discount provision. In addition to, or alternatively, an employer may set a target retirement age at which the individual/employee may qualify 330. For example, the individual may have the option to access discounted benefits at age 55 under their terms of employment. Alternatively, according to some embodiments, an individual may choose when they will receive discounted coverage.

Upon qualifying for early retirement, an individual may leave an employer or retire 340 early and elect to receive benefits at a discounted price by paying 350 premiums at the discounted price, which is available as a result of the individual previously paying 320 premiums under the insurance policy having the discount provision. In some implementations, the discounted benefits may cease upon the individual reaching a qualifying age for federal health insurance. Alternatively, the policy having discounted premiums may be converted to a supplemental health insurance plan upon an individual qualifying for federal health insurance.

Upon qualifying for early retirement under the insurance policy having the discount provision, an individual alternatively may elect to defer 360 coverage. In one instance, after deferring 360, an election 370 is made to receive benefits at a later time, but before the individual qualifies for federal medical insurance; and benefits may be maintained by paying 380 insurance premiums having a discounted cost as a result of previously paying 320 premiums under the insurance policy having the discount provision. In this situation, the individual may be required to meet predefined criteria that may include showing proof that they are covered under another insurance policy during their deferral period, such as an employer-sponsored group plan.

Once the individual elects to activate their benefits having discounted premiums, their medical coverage may change to one of a variety of predefined plans, which may include the same plan as when they were employed except that the premium cost will be discounted due to the discount aspect of the policy, e.g., the premiums are discounted due to the funds accumulated during the pre-discount period. Otherwise, the individual may have the option of choosing other medical coverage, such as one of a variety of high deductible health plans (HDHPs) having varying deductibles, out of pocket maximums, and lifetime maximums. Alternatively, the insurance coverage available to the retiree may be determined by the insurance provider based on the individual's age and the amount of funds contributed to during the pre-discount period.

In another implementation, after deferring 360, an election 375 is made to receive supplemental medical insurance coverage upon qualifying for federally funded insurance, e.g., Medicare. This may occur when the election is made after the individual has both retired and qualified to receive federally funded medical insurance. In this case, the individual may elect to receive supplemental insurance where the cost of paying 385 supplemental insurance premiums is offset due to previously paying 320 premiums under the insurance policy having the discount provision. Alternatively, an individual may elect to receive supplemental medical insurance coverage when they become eligible to receive Medicare due to disability or if the individual has other insurance available from an employer or Medicaid. In some cases, election of supplemental insurance coverage may occur upon the occurrence of a predetermined event rather than after a deferral period.

In some implementations, the type of insurance coverage available to an entity during a discount period may change over time. For example, discounted premiums may be available to an individual for a discount period of 10 years once the individual attains an age of 57. The type of insurance coverage available to the individual may be an individual health insurance plan for 8 years, i.e., until the individual reaches an age of 65, and then the type of coverage available may change to a supplemental health insurance plan for 2 years, i.e., until the individual reaches an age of 67. If the individual elects to receive individual insurance having discounted premiums before attaining an age of 65, then at age 65 the individual health insurance may be converted to a supplemental insurance policy, or a new supplemental insurance policy having a discounted premium price may be issued to the individual.

Dependents may also be covered under the insurance policy having the discount provision. For example, if during the individual's employment, dependents were covered under the employer-sponsored insurance policy, funds contributed to the post-retirement provision may be set to an amount to account for additional premiums required for dependents under the insurance policy having the discount provision. Alternatively, when the individual elects a health insurance policy having a discount provision, the policyholder may also elect to cover dependents only under the discount provision at the time of election. In this way, dependents not eligible for coverage under the policyholder's active insurance policy would be covered under the discounted insurance policy once activated.

Furthermore, an individual may convert the insurance policy having the discount provision to an individual conversion policy upon the occurrence of eligibility events set forth in an insurance policy having the discount provision certificate of coverage. However, the policyholder may be prevented from conversion if they have retired or are pensioned in accordance with the terms of the insurance policy having the discount provision. Such a conversion policy may be a standard policy with standard rates. Alternatively, the insurance policy may be created initially as a portable individual insurance policy having a discount provision.

The method for providing discounted insurance may apply to a variety of types of insurance, such as health, life, disability, liability, or property insurance to enable entities to avoid gaps in insurance coverage as their circumstances change.

The methods according to the present invention may be implemented using paper, paperless, and/or computer methods. In some implementations, various combinations of software and hardware may be used, as would be apparent to those of skill in the art and as desired by the user. In addition, the present invention may be implemented in conjunction with a general purpose or dedicated computer system having a processor and memory components.

From the above description and drawings, it will be understood by those of ordinary skill in the art that the particular embodiments shown and described are for purposes of illustration only and are not intended to limit the scope of the present invention. Those of ordinary skill in the art will recognize that the present invention may be embodied in other specific forms without departing from its spirit or essential characteristics. For example, an insurance policy having the discount provision may be provided to a policyholder initially holding an individual policy rather than an employer-sponsored policy. References to details of particular embodiments are not intended to limit the scope of the invention.

What is claimed is:

1. An insurance policy having a discount provision, under which an entity pays a required premium, to provide future access and a discounted price for future insurance coverage, said future insurance coverage available upon one or more predetermined events.

2. The insurance policy of claim 1, wherein future insurance coverage is provided under the insurance policy.

3. The insurance policy of claim 1, wherein the future insurance coverage is effected through another insurance policy

4. The insurance policy of claim 1, wherein the insurance policy is a health insurance policy.

5. The insurance policy of claim 1, wherein the insurance policy is a policy with dependents.

6. The insurance policy of claim 1, wherein the insurance policy is a group insurance policy.

7. The insurance policy of claim 1, wherein the insurance policy is an individual insurance policy.

8. The insurance policy of claim 1, wherein the discount provision provides a discounted group price for health insurance.

9. The insurance policy of claim 1, wherein the discount provision provides a discounted individual price for health insurance.

10. The insurance policy of claim 1, wherein the discounted price comprises a discounted percentage of a medical insurance rate.

11. The insurance policy of claim 1, wherein the discounted price comprises a discount based on a pre-paid amount.

12. The insurance policy of claim 1, wherein the discounted price comprises a discount of a fixed amount over a discount period.

13. The insurance policy of claim 1, wherein the discounted price is independent of a medical condition present in an individual.

14. The insurance policy of claim 1, wherein the entity is an employer.

15. The insurance policy of claim 1, wherein the entity is an individual,

16. The insurance policy of claim 1, wherein the entity is a non-employer sponsor of a group insurance plan.

17. The insurance policy of claim 1, wherein the insurance policy is associated with an insurance plan that insures active employees.

18. The insurance policy of claim 17, wherein the insurer of the insurance policy and the insurance plan that insures active employees are the same.

19. The insurance provision of claim 18, wherein the insurance plan meets minimum benefit requirements.

20. The insurance policy of claim 17, wherein the insurer of the insurance policy and the insurance plan that insures active employees are different.

21. The insurance policy of claim 20, wherein the insurance plan meets minimum benefit requirements.

22. The insurance policy of claim 1, wherein the future insurance coverage is a supplemental health insurance policy.

23. The insurance policy of claim 1, wherein the future insurance coverage is guaranteed.

24. A method for providing an insurance policy having a discount provision comprising:
creating an insurance policy having a discount provision, under which an entity pays a required premium, to provide future access and a discounted price for future insurance coverage, said future insurance coverage available upon one or more predetermined events;
collecting the required premium amount from the entity for a first period of time; and
upon cessation of payment of the required premium by the entity, providing insurance coverage to the entity and discounting the insurance premiums for a second period of time.

25. The method of claim 24, wherein creating the insurance policy is triggered upon receiving an indication of an election to participate in an employer-sponsored medical insurance policy having a discount provision.

26. The method of claim 24, wherein the entity is an individual and the insurance coverage provided is health insurance.

27. The method of claim 26, further comprising terminating the provided insurance coverage upon the individual reaching a qualifying age for federal health insurance.

28. The method of claim 26, further comprising converting the provided insurance coverage to supplemental health insurance coverage upon the occurrence of one or more predetermined events.

29. The method of claim 26, further comprising converting the provided insurance coverage to an to individual health insurance coverage upon the occurrence of one or more predetermined events.

30. The method of claim 24, wherein one of the one or more predetermined events comprises an individual attaining an age.

31. The method of claim 30, wherein the age comprises an age of 50-64.

32. The method of claim 24, wherein one of the one or more predetermined events comprises an individual paying premiums for at least a minimum period of time.

33. The method of claim 32, wherein the minimum period of time is 3-5 years.

34. The method of claim 24, wherein one of the one or more predetermined events comprises an individual attaining retirement.

35. The method of claim 24, further comprising changing the type of insurance coverage provided to the entity during the second period of time.

36. The method of claim 35, wherein changing the type of insurance coverage provided comprises changing insurance coverage to a supplemental health insurance policy.

37. The method of claim 24, further comprising associating the insurance policy with a payment vehicle that accepts future premium payments.

38. The method of claim 24, wherein the required premium amount is determined based on an age of the entity at the beginning of the first period of time.
